(19) United States
(12) Patent Application Publication
(10) Pub. No.: US 2026/0324861 A1
(43) Pub. Date: Oct. 22, 2026

(54) Releasable Attachment Tape and Systems Using the Same

(71) Applicant: Jack Wax, Deerfield, IL (US)

(72) Inventor: Jack Wax, Deerfield, IL (US)

(21) Appl. No.: 19/649,531

(22) Filed: Apr. 16, 2026

Related U.S. Application Data
(60) Provisional application No. 63/789,578, filed on Apr. 16, 2025.

(51) Int. Cl. A47B 95/02; F16B 11/00

(52) U.S. Cl. CPC A47B 95/02; F16B 11/006

(57) ABSTRACT

A mounting device includes a substrate, an adhesive layer, and a removable film covering the adhesive layer. The removable film comprises multiple layers and a pull tab configured such that pulling the tab causes relative movement between the layers to progressively expose the adhesive. The device may be positioned and aligned prior to full adhesive exposure. Methods of installation are also disclosed.

### RELATED APPLICATIONS

The present application claims the benefit of U.S. Provisional Patent Application Ser. No. 63/789,578, filed Apr. 16, 2025, titled “Releasable Attachment Tape and Systems Using the Same” to Jack Wax, the entire disclosure of which is expressly incorporated by reference herein.

### FIELD OF THE INVENTION

The present disclosure relates generally to mounting devices and adhesive attachment systems, and more particularly to adhesive mounting devices incorporating removable film structures configured to enable controlled exposure of adhesive during installation.

### BACKGROUND AND SUMMARY OF THE DISCLOSURE

This section introduces aspects that may help facilitate a better understanding of the disclosure. Accordingly, these statements are to be read in this light and are not to be understood as admissions about what is or is not prior art.

Adhesive mounting systems are commonly used to secure objects to surfaces without mechanical fasteners. Such systems often include pressure-sensitive adhesives covered by removable liners or films that must be removed prior to installation.

Conventional adhesive systems typically require full removal of a protective film before positioning the device. This can make precise alignment difficult, particularly where the adhesive engages the surface immediately upon contact.

In some applications, partial adhesion during positioning is undesirable because it can lead to misalignment, uneven bonding, or premature attachment.

The present disclosure addresses these limitations by providing a mounting device having a removable film structure configured to allow a user to position and align the device prior to exposing adhesive.

In certain embodiments, the removable film comprises multiple layers that are releasably connected and include a pull tab. Pulling the tab causes relative movement between the layers, progressively exposing adhesive while the device is maintained in a desired position.

In certain embodiments, a first adhesive portion is exposed and used to temporarily secure the device, while a second adhesive portion remains covered during alignment and is subsequently exposed after positioning.

In certain embodiments, the device comprises a handle configured to be adhered to a cabinet surface.

Advantageously, the disclosed system enables improved alignment, controlled adhesive exposure, and ease of installation.

According to one aspect of the present disclosure, a handle assembly is provided. The handle assembly comprises a handle body including a flange configured to mount on an edge of a cabinet face, an adhesive positioned on the flange, and a removable film covering the adhesive. The removable film has a first layer covering the adhesive and a second layer coupled to the first layer. The second layer overlaps the first layer to be positionable between the edge of the cabinet face and the first layer.

According to another aspect of the present disclosure, a handle is provided. The handle comprises a handle body configured to be positioned adjacent an edge of a mounting surface; an adhesive configured to adhere the handle body to the edge of the mounting surface; and means for progressively exposing the adhesive to the edge of the mounting surface while the handle body is positioned adjacent to the edge of the mounting surface.

### BRIEF DESCRIPTION OF THE DRAWINGS

The previously described aspects of this disclosure will grow to be appreciated at a greater level once references to the following accompanying illustrations are expounded upon.

FIG. 1 is a side view of a cabinet drawer and a handle adhered to the bottom of a face of the cabinet drawer.

FIG. 2 is a front view of the cabinet drawer and handle of FIG. 1 showing the handle extending below the front of the cabinet drawer.

FIG. 3 is a perspective view of the handle of FIG. 1.

FIG. 4 is a top view of the handle of FIG. 1.

FIG. 5 is a top assembly view of the handle of FIG. 1.

FIG. 6 is a perspective view of an alternative embodiment handle showing the curved and angled user-engagement portion of the handle.

FIG. 7 is a side view of the handle of FIG. 6 showing the handle positioned relative to a cabinet face shown in phantom.

The embodiments disclosed below are not intended to be exhaustive or limit the disclosure to the precise form disclosed in the following detailed description. Instead, the embodiments are chosen and described so that others skilled in the art may utilize their teachings. Unless otherwise indicated, the components shown in the figures are shown proportional to each other. It will be understood that no limitation of the scope of the disclosure is thereby intended. The disclosure includes any alterations and further modifications in the illustrative devices and described methods and further applications of the principles of the disclosure, which would normally occur to one skilled in the art to which the disclosure relates.

To promote an understanding of the principles of the present disclosure, reference will now be made to the embodiments illustrated in the drawings, and specific language will be used to describe the same. It will nevertheless be understood that no limitation of the scope of this disclosure is thereby intended.

### DETAILED DESCRIPTION OF THE DRAWINGS

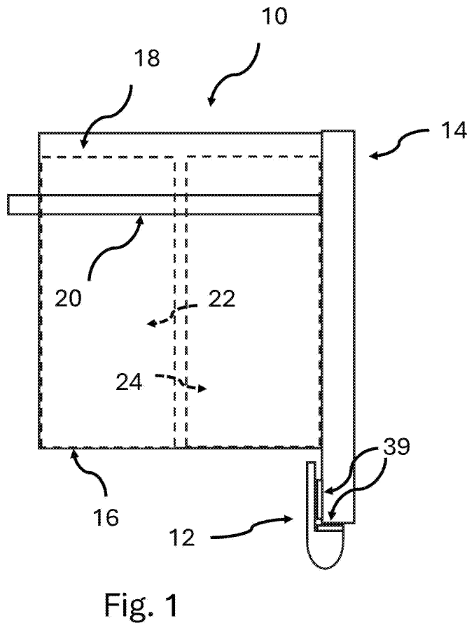

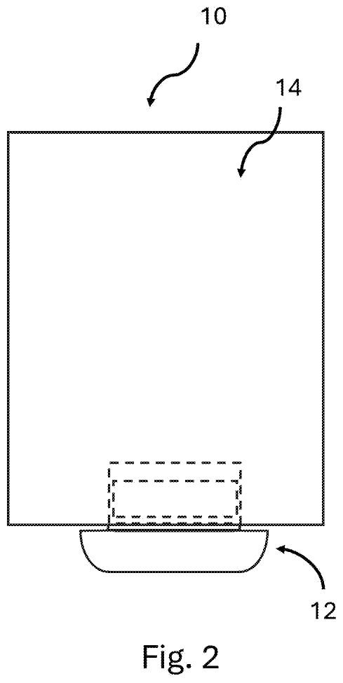

As shown in FIGS. 1 and 2, a cabinet drawer 10 is provided with a handle/handle assembly 12 adhered to a bottom of a cabinet front/face 14 of cabinet drawer 10. In addition to cabinet face 14, cabinet drawer 10 includes a bottom 16 and sides 18 (one shown) and rides on tracks 20 (one shown) supported by a cabinet frame (not shown) to allow cabinet drawer 10 to be opened and closed relative to the cabinet frame. In addition to cabinet drawers, handle 12 may also be used on other types of cabinetry such as swinging doors. Bottom 16 may support containers, such as a trash bin 22 (shown in phantom) and a recycling bin 24 (shown in phantom). To open cabinet drawer 10, a user may place their toes under and behind the handle 12 and then pull handle 12 outward with their toes. Handle 12 is useful for cabinet drawers 10 that may or may not have handles in a conventional location, such as at the top of face 14 of cabinet drawer 10.

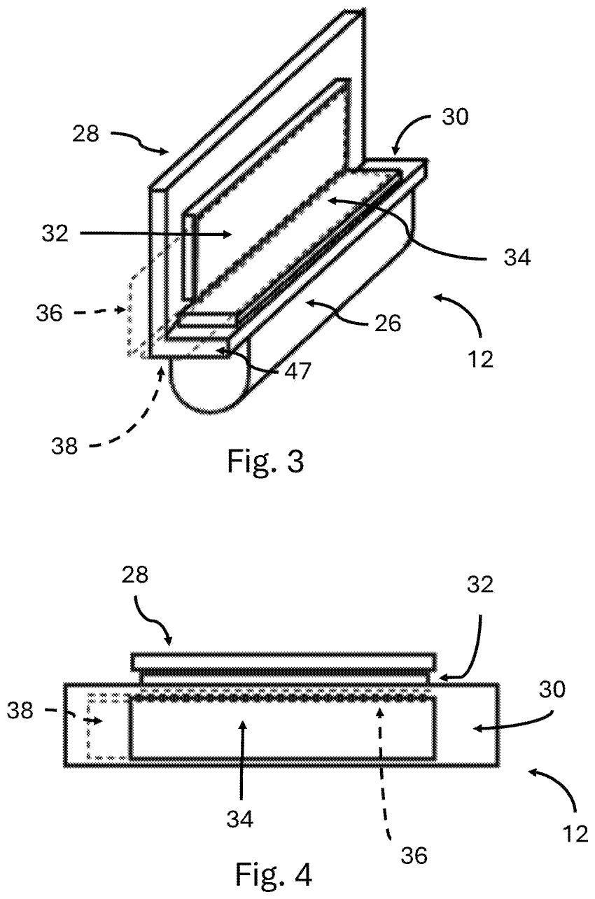

As shown in FIGS. 3 and 4, handle 12 includes a base/handle body 26 with a vertical flange/portion 28 extending vertically upward from base 26 and a horizontal flange/portion 30 extending horizontally outward from a lower end of vertical flange 28. Vertical flange 28 and horizontal flange 30 cooperate to define a 90-degree angle to match the bottom and back of cabinet face 14. Handle 12 is adhered to face 14 of cabinet drawer 10 by first and second double-sided adhesive foam tape strips/adhesive 32, 34. First adhesive strip/surface 32 adheres vertical flange 28 to a back side of the bottom of face 14 of cabinet drawer 10. Second adhesive strip/surface 34 adheres horizontal flange 30 to a bottom side of the bottom of face 14.

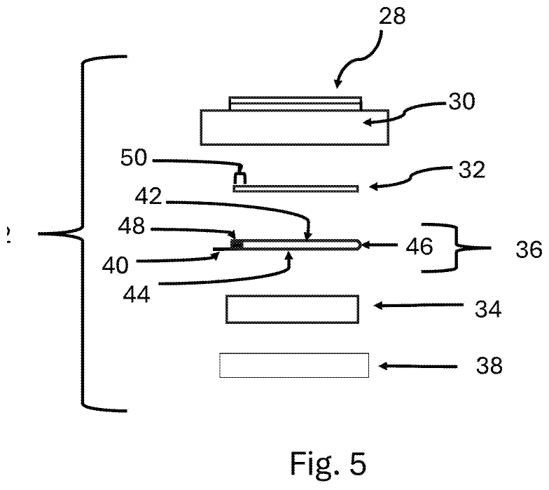

During manufacturing and prior to shipping from the manufacturer, the inward (i.e. facing toward the handle) side of first adhesive strip 32 is preferably adhered to vertical flange 28, and the inward side of second adhesive strip 34 is preferably adhered to horizontal flange 30. However, first and second adhesive strips 32, 34 are not preferably adhered to face 14 of cabinet drawer 10. Rather, outward (i.e. facing away from the handle) sides of first and second adhesive strips 32, 34 are covered respectively by first and second removable film strips/layers 36, 38 (shown in phantom in FIGS. 3 and 4 and in solid lines in FIG. 5) to cover the adhesive of the outward sides of first and second adhesive strips 32, 34. After being shipped to and received by a consumer, such as the end user, outward sides of first and second strips 32, 34 are adhered to face 14 of cabinet 10 after removing first and second film strips 36, 38.

To adhere handle 12 to mounting surfaces/edges 39 of face 14 of cabinet 10, a user first peels second film strip 38 from second adhesive strip 34, exposing the outward side of second adhesive strip 34. The user then aligns handle 12 with face 14, so that handle 12 is preferably centered on face 14 and positioned slightly below the bottom of face 14 with first film strip 36 positioned against a back of face 14 of cabinet 10. Next, a user raises handle 12 so that the outward side of second adhesive strip 34 comes into contact with the bottom of face 14, adhering horizontal flange 30 of handle 12 to face 14 of cabinet 10. During this process, first film strip 36 remains adhered to first adhesive strip 32 so that the adhesive of first adhesive strip 32 remains covered, not adhering to face 14 of cabinet 10 during the alignment of handle 12, allowing first film strip 36 to slide upwards relative to the back of face 14 of cabinet 10.

After second adhesive strip 34 is adhered to the bottom of face 14 of cabinet 10, vertical flange 28 is adhered to the back of face 14 of cabinet 10 by removing first film strip 36 from first adhesive strip 32. During manufacturing, first film strip 36 is folded to have first and second layers 42, 44 with an integral junction 46 therebetween. First layer 42 is positioned between first adhesive strip 32 and second layer 44. First layer 42 is adhered to second layer 44 with adhesive 48 near a tab 40 of first film strip 36 that extends from second layer 44 and beyond an edge 47 of handle 12.

According to an alternative embodiment, adhesive 48 is not provided and an alternative adhesive defined by a portion 50 of first adhesive strip 32 near tab 40 (i.e. the location occupied by adhesive 48 in the above embodiment) is not covered by first layer 42 as a result of shortening first layer 42 by an amount about that covered by adhesive 48 in the above embodiment, leaving portion 50 of first adhesive strip 32 exposed to second layer 44 so that second layer 44 adheres to portion 50 of first adhesive strip 32.

After second adhesive strip 34 is adhered to face 14 of cabinet 10, a user grabs tab 40 and pulls tab 40 of removable film 36 sideways, undoing the adhesive coupling between first and second layers 42, 44 provided by adhesive 48 (or portion 50 of first adhesive strip 32 and second layer 44 in the alternative embodiment). The user continues to pull on tab 40 so that junction 46 between first and second layers 42, 44 moves in the direction tab 40 is pulled, making second layer 44 longer and first layer 42 shorter and exposing a portion of the adhesive of first adhesive strip 32. As the user continues to pull on tab 40, second layer 44 lengthens, first layer 44 shortens, and more of first adhesive strip 32 is exposed until second layer 44 is gone, having fully transitioned into first layer 42, and first adhesive strip 32 is completely exposed and first film strip 36 is removed from first adhesive strip 32. Next, the user presses vertical flange 28 against the back of face 14 of cabinet 10 to adhere vertical flange 28 to face 14 of cabinet 10, using first adhesive strip 32.

According to an alternative embodiment, second film strip 38 may be configured similarly to first film strip 36, having first and second layers, a tab, and an adhesive securing the first and second layers, and the adhesive of second adhesive strip 34 may be exposed using the same process as first adhesive strip 32. Similarly, the double layer construction of first film strip 36 may be a single layer and second film strip 38 may be a double layer with first adhesive strip 32 being adhered to face 14 of cabinet 10, followed by second adhesive strip 34 being adhered to face 14 of cabinet 10.

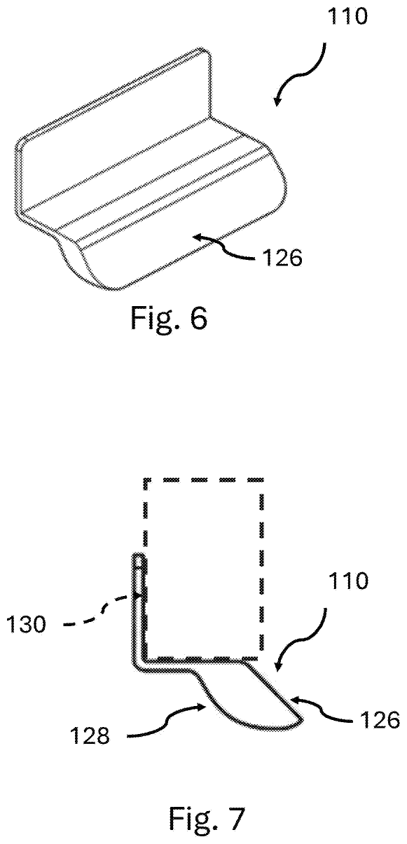

In one embodiment, and as shown in FIGS. 6 and 7, a handle 110 is provided that includes a base 126 to be actuated by a user's foot. Base 126 includes a curved lower surface 128 and an angled profile relative to a mounting surface 130 of face 14 (shown in phantom). Curved lower surface 128 is shaped to receive a portion of a user's foot to facilitate application of a pulling force. As shown, base 126 extends forward of face 14. Handle 110 may be adhered to face of cabinet drawer 10 using the components and methods described herein.

I claim:

1. A handle assembly comprising:
a handle body including a flange configured to mount on an edge of a cabinet face,
an adhesive positioned on the flange, and
a removable film covering the adhesive, the removable film having
a first layer covering the adhesive and
a second layer coupled to the first layer, the second layer overlapping the first layer to be positionable between the edge of the cabinet face and the first layer.

2. The handle assembly of claim 1, wherein the removable film has a pull tab extending from the second layer, the pull tab being configured to be pulled on by a user to move the second layer relative to the first layer, causing the first layer to be progressively removed from the adhesive and progressively exposing the adhesive to the edge of the cabinet face.

3. The mounting device of claim 1, wherein the pull tab extends outwardly beyond an edge of the handle body.

4. The mounting device of claim 1, wherein pulling the pull tab is configured to cause the second layer of the removable film to lengthen and the first layer of the removeable film to shorten.

5. The mounting device of claim 1, wherein the removable film is configured such that the adhesive is exposed progressively along a length of the handle body as the pull tab is pulled.

6. The handle assembly of claim 1, further comprising a releasable connection between the first layer of the removable film and the second layer of the removable film.

7. The mounting device of claim 6, wherein the releasable connection comprises an adhesive bond between the first layer of the removable film and the second layer of the removable film.

8. The mounting device of claim 1, wherein the adhesive is a double-sided adhesive tape.

9. The mounting device of claim 1, further comprising a second adhesive and a second removable film covering the second adhesive.

10. The mounting device of claim 9, wherein the second removable film is configured to be removable prior to positioning the flange of the handle body next to the edge of a cabinet face.

11. The mounting device of claim 1, wherein the flange of the handle body has a vertical portion and a horizontal portion when positioned on the edge of the cabinet face.

12. The mounting device of claim 11, wherein the vertical portion and horizontal portion are arranged at approximately a right angle.

13. A method of mounting a handle to a mounting surface of a cabinet face, the method comprising:
providing a handle assembly comprising a handle body, a first adhesive surface coupled to the handle body, a second adhesive surface coupled to the handle body, and a removable film covering the first adhesive surface;
abutting the handle assembly to the mounting surface of the cabinet face with the removable film covering the first adhesive surface;
removing the removable film from the first adhesive surface as the handle assembly abuts the mounting surface; and
adhering the handle assembly to the mounting surface with the first adhesive surface.

14. The method of claim 13, further comprising progressively exposing the first adhesive surface while pulling a tab of the removeable film during the removing step.

15. The method of claim 13, wherein pulling a tab of the removable film causes relative movement between a first layer of the removable film and a second layer of the removable film during the removing step.

16. The method of claim 13, further comprising pressing the handle assembly against the mounting surface during the adhering step.

17. A handle comprising:
a handle body configured to be positioned adjacent an edge of a mounting surface;
an adhesive configured to adhere the handle body to the edge of the mounting surface; and
means for progressively exposing the adhesive to the edge of the mounting surface while the handle body is positioned adjacent to the edge of the mounting surface.

18. The handle of claim 17, wherein the exposing means provides relative movement between a first layer of a removable film and a second layer of the removable film to progressively expose the adhesive.

19. The handle of claim 18, wherein the exposing means includes a pull tab coupled to the second layer.
